(19) United States
(12) Patent Application Publication
(10) Pub. No.: US 2026/0071947 A1
(43) Pub. Date: Mar. 12, 2026

(54) HIGH-PRESSURE HIGH-TEMPERATURE CORE HOLDER FOR X-RAY COMPUTED TOMOGRAPHY

(71) Applicant: UNIVERSITY OF WYOMING, Laramie, WY (US)

(72) Inventors: Ziqiang QIN, Laramie, WY (US); Maziar ARSHADI, Laramie, WY (US); Mahdi KHISHVAND, Laramie, WY (US); Mohammad PIRI, Laramie, WY (US)

(21) Appl. No.: 19/327,809

(22) Filed: Sep. 12, 2025

Related U.S. Application Data
(60) Provisional application No. 63/694,003, filed on Sep. 12, 2024.

(51) Int. Cl. G01N 15/08; G01N 23/046

(52) U.S. Cl. CPC G01N 15/0806; G01N 15/082; G01N 23/046; G01N 2223/1016

(57) ABSTRACT

Embodiments of the present disclosure generally relate to core holders and uses thereof in, for example, core-flood testing. In an embodiment is provided a core holder. The core holder includes a core tube defining an outside diameter of the core holder, the core tube formed of an X-ray transparent material. The core holder further includes an internal sleeve in the core tube, the internal sleeve formed of a flexible material, the internal sleeve comprising: an inner diameter defining an interior volume of the core holder and adapted to accommodate a core sample; and an outer diameter. The core holder further includes a first end piece and a second end piece opposite the first end piece, each of the first end piece and the second end piece: adhered to an outer diameter of the core tube; and adjacent to a confining fluid chamber.

### CROSS-REFERENCE TO RELATED APPLICATIONS

This application claims benefit of and priority to U.S. Patent Application No. 63/694,003, filed on Sep. 12, 2024, which is incorporated herein by reference in its entirety.

### FIELD

Embodiments of the present disclosure generally relate to core holders and uses thereof in, for example, core-flood testing.

### BACKGROUND

X-ray tomography technology provides opportunities to visualize and study various aspects of core flooding including three-dimensional fluid occupancies and calculating in situ fluid saturation in natural porous media. Such imaging and information enables researchers to assess formations and designs for oil recovery. In laboratory experiments, conventional core holders include a main body made of metal materials such as aluminum, nickel alloys, or titanium. These metal materials, however, absorb significant amounts of X-rays during imaging. Therefore, when using conventional core holders made of metal materials, image quality of the geomaterial matrix and the contained fluids in the porous media is poor.

Conventional carbon fiber core holders are often designed and manufactured to house miniature samples (for example, outer diameter (OD): 5-10 mm) only and are only for use in micro-scale X-ray imaging. Conventional carbon fiber core holders do not house large samples (for example, OD: 1″, 1.5″, or 4″) and cannot be integrated with macro-scale X-ray imaging. While conventional carbon fiber core holders can be used at elevated pressures and temperatures, such pressures and temperatures are not high and are nowhere close to actual field conditions for subsurface systems. Overall, conventional technologies have not achieved core holders having both imaging abilities and abilities to withstand actual conditions that mimic or simulate those observed in the field.

There is a need for new core holders.

### SUMMARY

Embodiments of the present disclosure generally relate to core holders and uses thereof in, for example, core-flood testing. Unlike conventional technologies, core holders described herein enable both X-ray imaging and investigations of the fluid flow through core sample under actual conditions (high temperature and high pressure) observed in the field. Such actual conditions include: overburden pressures (for example, from about 1,000 psi to about 10,000 psi); core pressures (for example, from about 200 psi to about 8,000 psi); and temperature (for example, from about 104° F. to about 250° F.). These temperatures and pressures may be held for several months, for example, 2-12 months.

In an embodiment, a high-pressure, high-temperature core holder adapted to be coupled to an X-ray computed tomography scanner is provided. The core holder includes a core tube defining an outside diameter of the core holder, the core tube formed of an X-ray transparent material. The core holder further includes an internal sleeve in the core tube, the internal sleeve formed of a flexible material comprising a fluoroelastomer, the internal sleeve comprising: an inner diameter defining an interior volume of the core holder and adapted to accommodate a core sample; and an outer diameter. The core holder further includes a first end piece and a second end piece opposite the first end piece, each of the first end piece and the second end piece: adhered to an outer diameter of the core tube with a structural adhesive; and adjacent to a confining fluid chamber.

In another embodiment, a high-pressure, high-temperature core holder adapted to be coupled to an X-ray computed tomography scanner is provided. The core holder includes a core tube defining an outside diameter of the core holder, the core tube formed of an X-ray transparent material. The core holder further includes an internal sleeve in the core tube, the internal sleeve formed of a flexible material comprising a fluoroelastomer, the internal sleeve comprising: an inner diameter defining an interior volume of the core holder and adapted to accommodate a core sample; and an outer diameter. The core holder further includes a first end piece and a second end piece opposite the first end piece, each of the first end piece and the second end piece: adhered to an inner diameter of the core tube with a structural adhesive; and adjacent to a confining fluid chamber.

In another embodiment, a core-flooding apparatus adapted to perform a core-flood test is provided. The core-flooding apparatus includes a core holder described herein, the core holder adapted to be coupled to an X-ray computed tomography scanner system to monitor imbibition or saturation of a core sample comprising a geomaterial sample.

In another embodiment, a process is provided. The process includes performing a core-flood test on a core sample disposed inside a core holder described herein, the core sample comprising porous media; collecting X-ray computed tomography images of the core sample while performing the core-flood test; and determining characteristics of the core sample and a fluid in the porous media of the core sample based on the X-ray computed tomography images, the characteristics of the core sample and the fluid in the porous media comprising: a porosity, a permeability, relative permeability, a fluid saturation, saturation change, damage caused by a fluid injection, interaction between a fluid injected and the core sample, or combinations thereof.

### BRIEF DESCRIPTION OF THE DRAWINGS

So that the manner in which the above recited features of the present disclosure may be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is an exploded view of an example core holder showing various components according to at least one embodiment of the present disclosure.

FIG. 2A is a cross-sectional view of an example core holder according to at least one embodiment of the present disclosure.

FIG. 2B is a partial cross-sectional view of the example core holder of FIG. 2A according to at least one embodiment of the present disclosure.

FIG. 3A is a side perspective view of an example end piece according to at least one embodiment of the present disclosure.

FIG. 3B is a top view of the example end piece shown in FIG. 3A according to at least one embodiment of the present disclosure.

FIG. 3C is a side cross-sectional view of the example end piece shown in FIG. 3A according to at least one embodiment of the present disclosure.

FIG. 3D is a side view of the example end piece shown in FIG. 3A according to at least one embodiment of the present disclosure.

FIG. 3E is a cross-sectional view of a port of the example end piece shown in FIG. 3A according to at least one embodiment of the present disclosure.

FIG. 4A is a side view of an example end cone according to at least one embodiment of the present disclosure.

FIG. 4B is a cross-sectional view of the example end cone shown in FIG. 4A according to at least one embodiment of the present disclosure.

FIG. 5A is a side perspective view of an example nozzle according to at least one embodiment of the present disclosure.

FIG. 5B is a top view of the example nozzle shown in FIG. 5A according to at least one embodiment of the present disclosure.

FIG. 5C is a side cross-sectional view of the example nozzle shown in FIG. 5A according to at least one embodiment of the present disclosure.

FIG. 5D is a top cross-sectional view of the example nozzle shown in FIG. 5A according to at least one embodiment of the present disclosure.

FIG. 6 is a cross-sectional view of an example core holder according to at least one embodiment of the present disclosure.

FIG. 7A is a side view of an example end piece according to at least one embodiment of the present disclosure.

FIG. 7B is a cross-sectional view, taken along segment A-A, of the example end piece shown in FIG. 7A according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to core holders and uses thereof in, for example, core-flood testing. As discussed above, it is challenging when employing conventional core holders made of metal materials to image and visualize geomaterial samples (porous media) and the contained fluids during investigations as conventional core holders are made of X-ray obscuring materials. Those conventional carbon fiber core holders that utilized for imaging, however, cannot be integrated with macro-scale X-ray imaging and cannot be used under actual conditions. That is, conventional technologies have not achieved core holders having both imaging abilities and abilities to withstand actual conditions that mimic or simulate those observed in the field.

To overcome these and other challenges, the inventors have discovered new and improved core holders that enable X-ray imaging of core samples and the ability to perform investigations (including X-ray imaging) of fluid flow through core samples under actual conditions. The core holders of the present disclosure include:
(i) a core tube comprised of, or formed of, an X-ray transparent material;
(ii) an internal sleeve in the core tube, the internal sleeve comprised of, or formed of, a flexible material such as a fluoroelastomer, the fluoroelastomer comprising a copolymer comprising tetrafluoroethylene and propylene; and
(iii) an adhesive (such as an epoxy resin) adhering the core tube to an end piece(s) of the core holder, and the end piece(s) are disposed between the core tube and the internal sleeve.

This configuration is advantaged over conventional core holders, enabling both imaging and investigations of fluid flow through core samples under actual conditions that mimic or simulate those observed in the field. For example, the carbon fiber of the core tube enables X-ray imaging and maintains mechanical integrity under high stress conditions. The fluoroelastomer internal sleeve minimizes gas diffusion between the porous media of the core sample and the confining fluid chamber environment. The adhesive provides additional mechanical strength to the core holder by adhering the core tube and the end pieces to one another. The carbon fiber core tube, fluoroelastomer internal sleeve, and adhesive allow studies under actual conditions: such as, for example, overburden pressures (for example, from about 1,000 psi to about 10,000 psi (from about 6.9 MPa to about 69 MPa); core pressures (for example, from about 200 psi to about 8,000 psi (from about 1.4 MPa to about 55 MPa)); and temperature (for example, from about 104° F. to about 250° F. (from about 40° C. to about 120° C.)). Further, embodiments described herein enable testing of one or more fluids at a time. For example, a single fluid (for example, an oil or aqueous fluid) alone may be investigated. As another example, two fluids (for example, an oil and an aqueous fluid) may be investigated together. As another example, three fluids (for example, an oil, an aqueous fluid, and a gas) may be investigated together.

Embodiments of the present disclosure provide apparatus and methods for, for example, conducting core-flood tests and for evaluating effectiveness of hydrocarbon recovery techniques. For example, embodiments described herein may be utilized to perform core-flood tests for evaluating the effects of fluid(s) injection in order to improve recovery of hydrocarbons from formations. A formation may include a subterranean formation and/or porous formation. A formation may include those already subjected to recovery operations, such as primary, secondary, and/or tertiary recovery operations. A formation may also include those not yet subject to such recovery operations.

A formation may contain hydrocarbons. Hydrocarbons may include oil, natural gas, and/or any suitable mixtures of these and other hydrocarbons. Although this disclosure generally references “oil” recovery, the example techniques may be applied, adapted, or otherwise implemented to evaluate the effectiveness of recovery of other hydrocarbons from the subterranean region.

Generally, a core-flood test is a laboratory test in which a fluid(s) is injected into a core sample. The effects of the fluid injection on the core sample and the fluids in the porous media of the sample, such as permeability, relative permeability, saturation change, formation damage caused by the fluid injection, and/or interactions between the fluid and the core sample, may be measured and their effects on oil recovery may be evaluated. Core-flood testing helps engineers design and improve development options for an oil reservoir. A core-flood test may include a saturation process. A core-flood test may include an imbibition process, which is a process of absorbing a phase (for example, water) into a porous core sample. Imbibition processes may be classified into forced imbibition and spontaneous imbibition, which generally refer to the process of absorption with and without pressure driving the wetting phase into the core sample, respectively. Improving the imbibition process is an example technique for increasing the flow capability, and thus improving oil recovery.

Core-flood experiments may include two tests or phases: a saturation test and an imbibition test. In a saturation test, a confining pressure is applied while saturating the core with brine followed by oil. The imbibition test then starts, during which injected fluids may selectively channel through the porous media towards the outlet.

Embodiments described herein may enable, for example, conducting core-flooding experiments of the core sample while the core holder is mounted to an X-ray CT scanner positioning table. Embodiments of the present disclosure provide X-ray CT imaging of in-situ fluid distribution within the core. The X-ray CT scanner may be adapted for macro-scale X-ray imaging (for example, ODs: 1″, 1.5″, or 4″, among other ODs). The X-ray CT scanner may be adapted for micro-scale x-ray imaging.

Core samples utilized with embodiments described herein may include any suitable core sample. The core sample may include a porous media such as a porous geomaterial. The geomaterial may be intact, fractured, or combinations thereof. The geomaterial may be a naturally-occurring geomaterial, a synthetic geomaterial, or combinations thereof. Illustrative, but non-limiting, examples of core samples may include carbonate, sandstone, shale, or combinations thereof, among other suitable types of geomaterial or rock materials. Samples useful with embodiments of the present disclosure are not limited to geomaterials. For example, a sample may include any suitable porous material such as bone.

Samples and core samples may have any suitable dimensions. For example, samples and core samples may have a diameter in a range from about 5 millimeters (mm) to about 4 inches.

The figures and description thereof are described with respect to a macro-scale core holder design.

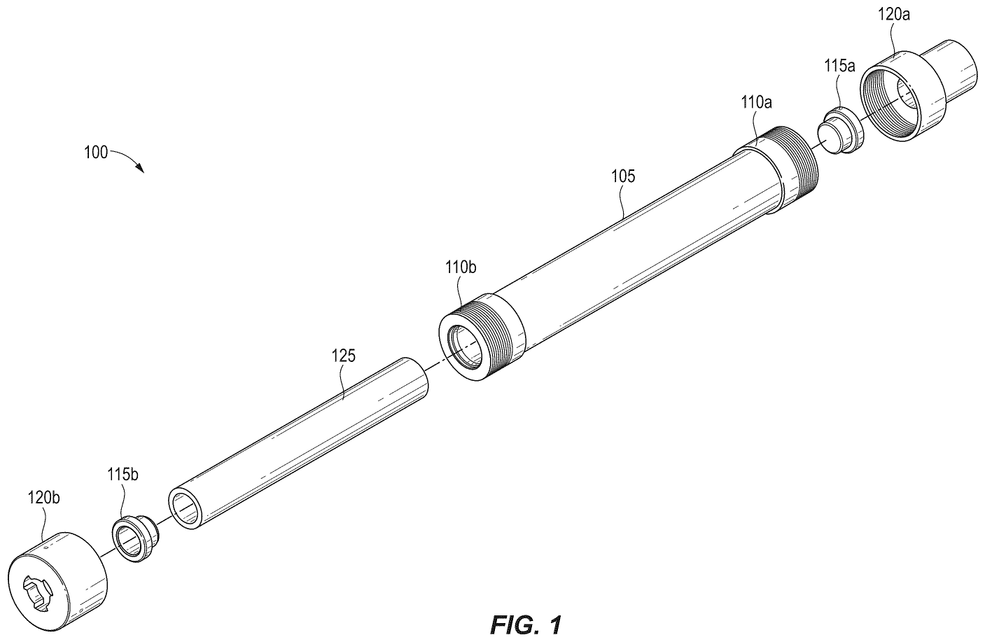

FIG. 1 is an exploded view of an example core holder 100 showing various components according to at least one embodiment of the present disclosure. Core holders described herein include a core tube 105, a first end piece 110a, a second end piece 110b, a first end cone 115a, a second end cone 115b, a first end cap 120a, a second end cap 120b, and an internal sleeve 125.

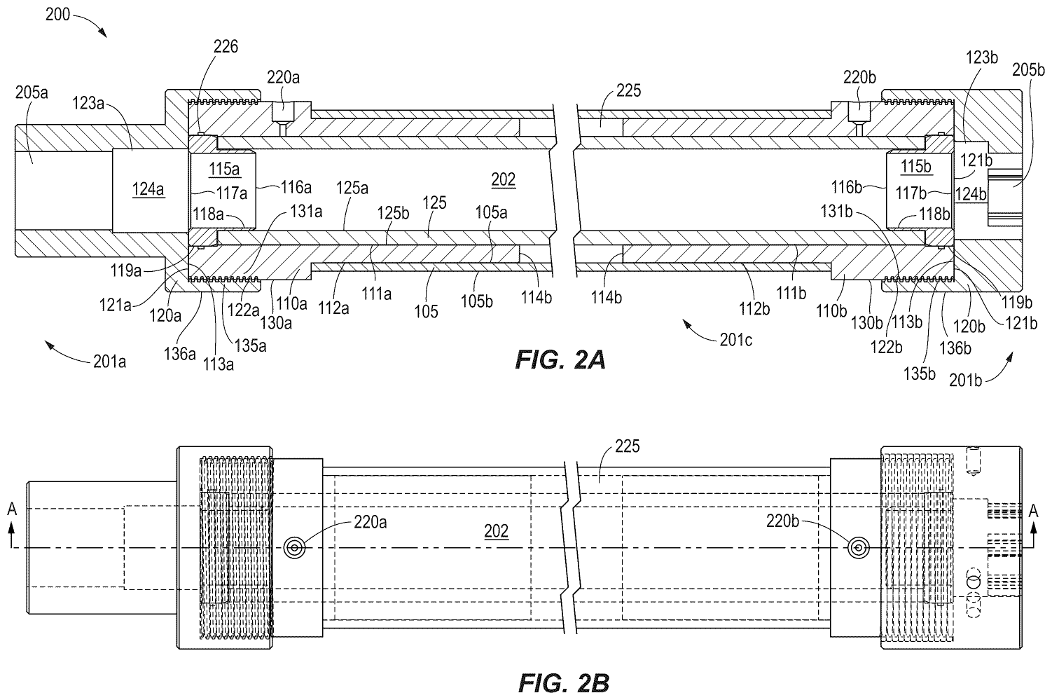

FIG. 2A is a cross-sectional view of an example core holder 200 according to at least one embodiment of the present disclosure. The cross-sectional view of the core holder 200 shown in FIG. 2A is taken along segment A-A of the core holder shown in FIG. 2B. The example core holder 200 includes a core tube 105 that defines a portion of an outer diameter 201c of the example core holder 200. The example core holder 200 also includes an internal sleeve 125 that defines an inner diameter of the example core holder 200. Portions of end pieces 110a, 110b are positioned between the core tube 105 and the internal sleeve 125. Portions of end cones 115a, 115b are positioned inside an inner diameter of the internal sleeve 125. The end cones 115a, 115b and the inner diameter of the internal sleeve 125 form an interior volume 202 of the example core holder 200. The interior volume 202 is adapted to accommodate a core sample for investigation, for example, core-flood testing. The example core holder 200 includes a first end 201a and a second end 201b. Each of the two ends 201a, 201b are defined by an end cap 120a, 120b threadedly coupled to an end piece 110a, 110b, respectively. During use, the example core holder 200 may be positioned vertically such that the first end 201a is a top end of the example core holder 200 and the second end 201b is a bottom end of the example core holder 200.

The core tube 105 comprises, or is formed of, an X-ray transparent material such as carbon fiber. The carbon fiber of the core tube enables X-ray imaging and maintains mechanical integrity under high stress conditions. The core tube 105 includes a first surface 105a and a second surface 105b. The first surface 105a of the core tube 105 defines an inner diameter of the core tube 105. The second surface 105b defines an outer diameter of the core tube 105 and defines at least a portion of the outer diameter 201c of the example core holder 200.

The example core holder 200 further includes a first end piece 110a and a second end piece 110b piece opposite the first end piece 110a. End pieces 110a, 110b (collectively, end pieces 110) may be made of, or formed of, any suitable material such as aluminum, nickel, an aluminum alloy, a nickel alloy (for example, Hastelloy), stainless steel, or combinations thereof. One or both end pieces 110a, 110b may be anodized. Each of the end pieces 110 includes: a first surface 111a, 111b (collectively, first surface 111); a second surface 112a, 112b (collectively, second surface 112) opposite the first surface 111; a third surface 113a, 113b (collectively, third surface 113); a fourth surface 114a, 114b (collectively, fourth surface 114) opposite the third surface 113; a fifth surface 130a, 130b (collectively, fifth surface 130) opposite the first surface 111; and threads 131a, 131b (collectively, threads 131) defining a portion of the fifth surface 130. The first surface 111 defines an inner diameter of the end piece 110. The second surface 112 may define a first outer diameter of the end piece 110. The fifth surface 130 and threads 131 may define a second outer diameter of the end piece 110, the second outer diameter being outside (and larger than) the first outer diameter of the end piece 110.

Each end piece 110 extends a certain length down the core tube 105 such that when the two end pieces 110 are coupled to the core tube 105, a void about the core tube 105 is created. This void forms a portion of confining fluid chamber 225 described below.

The second surface 112 of each end piece 110 is coupled to (or adhered to or bonded to) the first surface 105a of the core tube 105 by an adhesive. The adhesive is a structural adhesive. The adhesive may be any suitable resin such as an epoxy resin. Suitable epoxy resins include Hysol epoxy resin. A suitable Hysol epoxy resin includes Henkel Loctite Hysol EA 9394 C-2 Aero Epoxy commercially available from Krayden.

The second surface 112 of each end piece 110 may have a roughened or textured surface. The roughened/texture surface may increase the coupling (or adhering or bonding) strength between the second surface 112 of each end piece 110 and the first surface 105a of the core tube 105.

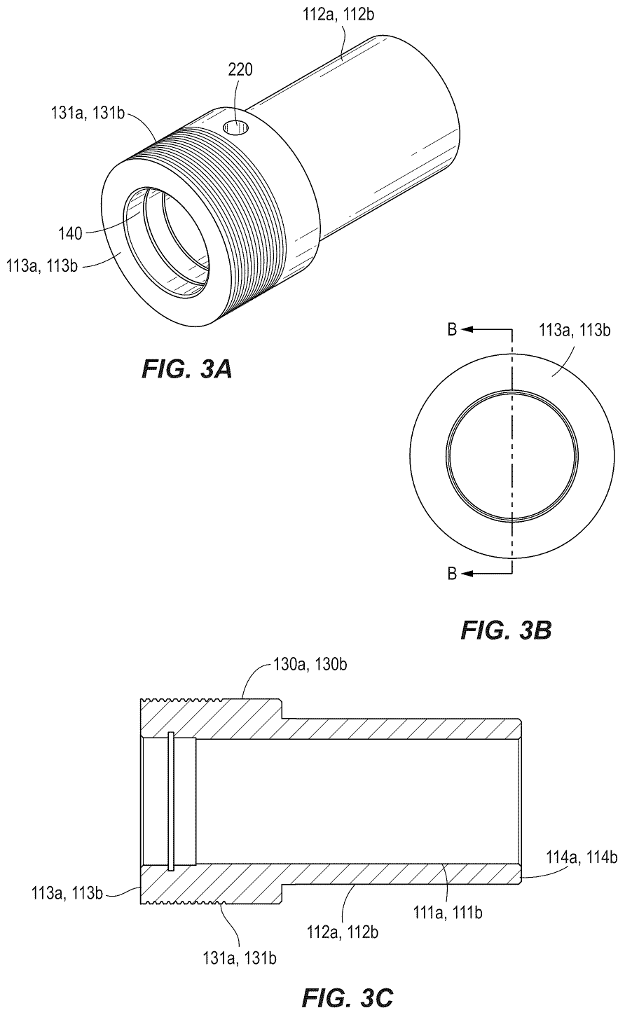

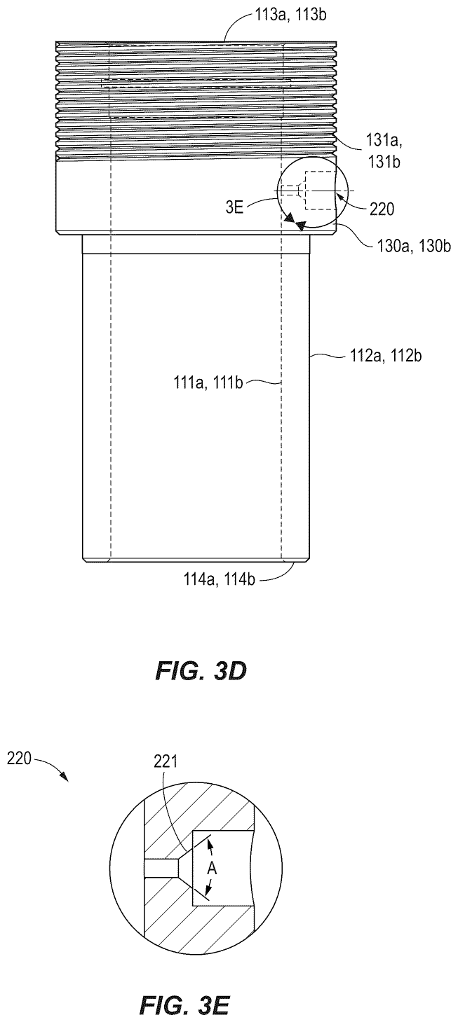

FIGS. 3A-3E show different views of a non-limiting example of the end piece 110 for a macro-scale core holder design. Specifically, FIG. 3A shows a side perspective view of the end piece 110, FIG. 3B shows a top view of the end piece 110, FIG. 3C shows a side cross-sectional view taken along segment B-B of the end piece 110 shown in FIG. 3B, and FIG. 3D shows a side view of the end piece 110. As illustrated in FIG. 3A, the end piece 110 includes interior grooves 140. An o-ring may be positioned in the grooves to seal a confining fluid. The o-ring may be made of any suitable material such as a fluoroelastomer described herein. As illustrated in FIG. 3D, the end piece 110 includes a confining fluid port 220. Confining fluid may travel through the confining fluid port 220 to the confining fluid chamber 225. FIG. 3E is a cross-sectional view of the confining fluid port 220. The opening 221 of the confining fluid port may be any suitable angle (A), for example, an angle in a range from about 50 degrees to about 100 degrees, such as from about 70 degrees to about 80 degrees.

The internal sleeve 125 has a first surface 125a and a second surface 125b opposite the first surface 125a. The first surface 125a of the internal sleeve 125 defines an inner diameter of the internal sleeve 125 and the second surface 125b of the internal sleeve 125 defines an outer diameter of the internal sleeve 125. The inner diameter (first surface 125a) of the internal sleeve 125 defines an interior volume of the example core holder 200. The interior volume of the example core holder 200 is adapted to receive a core sample for investigations, for example, core-flood testing.

The internal sleeve 125 comprises, or is formed of, a flexible material such as a rubber or an elastomer. The flexibility of the internal sleeve enables confining pressures to be placed on the core sample during investigations. Suitable rubbers or elastomers include fluoroelastomers, such as those fluoroelastomers comprising a copolymer comprising tetrafluoroethylene and propylene. Examples of fluoroelastomers suitable for use as an internal sleeve include AFLAS fluoroelastomers commercially available from Seals Eastern Inc. (New Jersey). An example AFLAS fluoroelastomer includes 90 durometer black AFLAS fluoroelastomer (compound 7182B). The fluoroelastomer minimizes gas (CO₂, hydrocarbon, etc.) diffusion between the core sample and other portions of the example core holder 200.

The example core holder 200 further includes one or more confining fluid ports. In FIG. 2, the example core holder 200 includes two confining fluid ports 220a, 220b (collectively, confining fluid ports 220) through which a confining fluid flows. The confining fluid ports 220 are in fluid communication with a confining fluid chamber 225. A portion of the confining fluid chamber 225 is defined by the core tube 105, the internal sleeve 125, and the two end pieces 110a, 110b. More specifically, a portion of the confining fluid of the confining fluid chamber 225 is defined by the first surface 105a of the core tube 105, the second surface 125b of the internal sleeve 125, and the fourth surfaces 114a, 114b of the first and second end pieces 110a, 110b, respectively.

Although not shown, a portion of the confining fluid chamber 225 extends along the first surface 111 (inner diameter) of the end piece 110 and the second surface 125b (outer diameter) of the internal sleeve 125. O-ring 226 may be used to prevent confining fluid from escaping the confining fluid chamber 225.

The confining fluid chamber 225 is adapted to accommodate a confining fluid (such as mineral oil) to apply confining pressure to the internal sleeve 125. During use, confining fluid is transmitted to the confining fluid chamber 225 through the confining fluid ports 220. The internal sleeve 125 is, for example, adapted to contact a core sample in response to a confining pressure applied to the internal sleeve 125 in the confining fluid chamber 225.

The example core holder 200 further includes a first end cone 115a and a second end cone 115b opposite the first end cone 115a. The first end cone 115a and the second end cone 115b are adapted to seal opposite ends of the interior volume 202 of the example core holder 200. The end cones 115a, 115b (collectively, end cones 115) may be made of, or formed of, any suitable material such as aluminum, nickel, an aluminum alloy, a nickel alloy (for example, Hastelloy), stainless steel, or combinations thereof, such as the nickel alloy. One or both end cones 115a, 115b may be anodized. Each end cone 115 includes: a first surface 116a, 116b (collectively, first surface 116); a second surface 117a, 117b (collectively, second surface 117) opposite the first surface 116; a third surface 118a, 118b (collectively, third surface 118); and a fourth surface 119a, 119b (collectively, fourth surface 119). The third surface 118 of the end cone 115 defines a first outer diameter of the end cone 115. The fourth surface 119 of the end cone 115 defines a second outer diameter of the end cone 115. The second outer diameter (the fourth surface 119) of the end cone 115 is larger than the first outer diameter of the end cone 115. The first outer diameter (the third surface 118) of the end cone 115 is coupled to (or may contact) the inner diameter (the first surface 125a) of the internal sleeve 125. The second outer diameter (the fourth surface 119) of the end cone 115 is coupled to (or may contact) the first surface 111 (inner diameter) of the end piece 110.

The end cones 115 and the internal sleeve 125 define the interior volume 202 of the example core holder 200. Specifically, the interior volume 202 of the example core holder 200 is defined by the first surface 116a of the first end cone 115a, the first surface 116b of the second end cone, and the first surface 125a (inner diameter) of the internal sleeve 125. The third surface 118 (first inner diameter) of the end cone 115 is adapted to fit inside the internal sleeve 125 and is coupled to the first surface 125a (inner diameter) of the internal sleeve 125. The fourth surface 119 (second outer diameter) of the end cone 115 is coupled to the first surface 111 (inner diameter) of the end piece 110. One or more o-rings may be located on the second outer diameter (the fourth surface 119) of the end cone 115. For example, the one or more o-rings may be located on the second outer diameter (the fourth surface 119) of the end cone 115 and fit into an interior groove 140 of the end piece 110. The one or more o-rings serve to prevent confining fluid from exiting the confining fluid chamber. The one or more o-rings are made of any suitable material such as those fluoroelastomers described above.

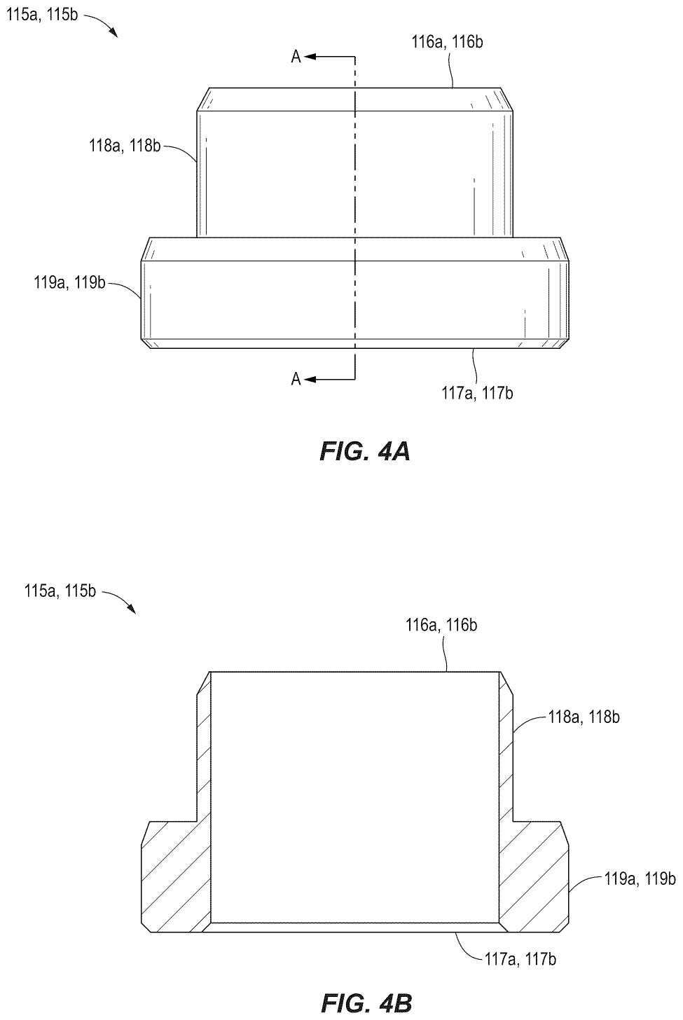

FIGS. 4A and 4B show a side view and a cross-sectional view, respectively, of a non-limiting example of the end cone 115 for a macro-scale core holder design. The cross-sectional view of the end cone 115 shown in FIG. 4B is taken along segment A-A of the end cone 115 shown in FIG. 4A.

The example core holder 200 further includes a first end cap 120a and a second end cap 120b opposite the first end cap 120a. The first end cap 120a and the second end cap 120b define the first end 201a and the second end 201b, respectively, of the example core holder 200. Each of the end caps 120a, 120b (collectively, end cap 120) includes: (i) a first surface 121a, 121b (collectively, first surface 121); (ii) a second surface 135a, 135b (collectively, second surface 135) perpendicular to the first surface 121 of the end cap 120, the second surface 135 of the end cap 120 defining an inner diameter of the end cap 120; (iii) a third surface 136a, 136b (collectively, third surface 136) perpendicular to the first surface 121 of the end cap 120, the third surface 136 of the end cap 120 defining an outer diameter of the end cap 120; and threads 122a, 122b (collectively, threads 122) defining at least a portion of the second surface 135 of the end cap 120. The first surface 121 of the end cap 120 has a diameter that matches or is near to the inner diameter (second surface 135) of the end cap 120.

The end cap 120 is secured to the end piece 110 via the threads 122 of the end cap 120 and the threads 131 of the end piece 110. The first surface 121 traps the end piece 110 and the end cone 115 upon securing the end cap 120 to the end piece 110. Upon securing, the first surface 121 of the end cap 120 and the third surface 113 of the end piece 110 are adjacent. The first surface 111 of end piece 110 contacts the second surface 125b (outer diameter) of the internal sleeve 125. The end caps 120a, 120b further include sidewalls 123a, 123b (collectively, sidewalls 123). The sidewalls 123a, 123b of the end caps 120a, 120b define an interior volume 124a, 124b, respectively, in which a first nozzle 205a and a second nozzle 205b are disposed, respectively. The end cap 120 may be made of, or formed of, any suitable material such as a nickel alloy, such as Hastelloy.

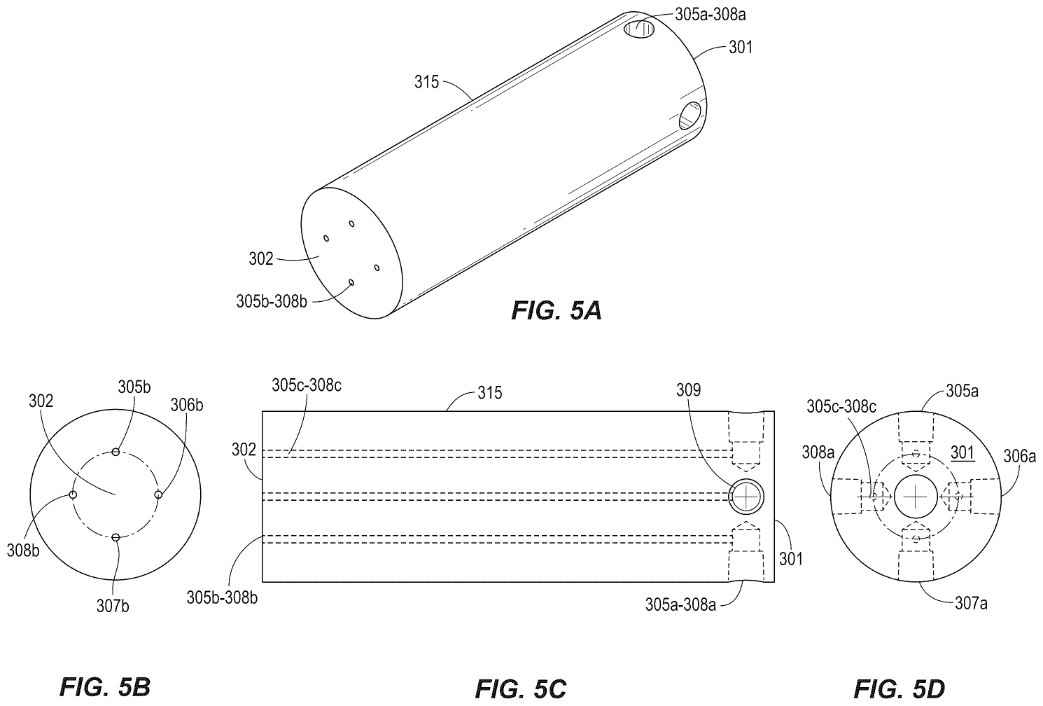

The first nozzle 205a is positioned opposite the second nozzle 205b. The second nozzle 205b may have the same or similar configuration as the first nozzle 205a. Each of the first nozzle 205a and the second nozzle 205b (collectively, nozzles 205) comprises a plurality of ports 305-308 (shown in FIGS. 5A-5D), such that the first nozzle 205a comprises a first plurality of ports and the second nozzle comprises a second plurality of ports. The plurality of ports 305-308 are in fluid communication with the interior volume 202 of the example core holder 200. The plurality of ports 305-308 are operable to inject or collect fluid(s) (for example, liquids and/or gases) into the interior volume of the example core holder 200 and to the core sample. The outer diameter 315 of the nozzles 205 fits into the internal diameters of the end cones 115. Fluids that may be injected or collected may include a hydrocarbon, an oil, natural gas, an aqueous fluid (for example, brine), CO₂, CH₄, N₂, H₂, or combinations thereof, among other fluids.

FIGS. 5A-5D show various views of the nozzles 205. The nozzles 205 include the plurality of ports 305-308. The nozzles 205 include a first end 301 and a second end 302 opposite the first end 301. Each of the plurality of ports 305-308 include a fluid entry 305a-308a, proximate to the first end 301 of the nozzles 205; a fluid exit 305b-308b located on the second end 302 of the nozzles 205; and a volume 305c-308c therebetween.

As described above, the first nozzle 205a and the second nozzle 205b are disposed in the respective interior volumes 124a, 124b (collectively, interior volume 124) of the respective end caps 120a, 120b. During investigations, fluids (gases and/or liquids) are injected into the core sample by flowing such fluids through the plurality of ports 305-308 of first nozzle 205a into the interior volume 202 of the example core holder 200 wherein the core sample is located. The fluids are collected from the core sample by the second plurality of ports of the second nozzle 205b. A hole can be bored at location 309 for a mounting stud.

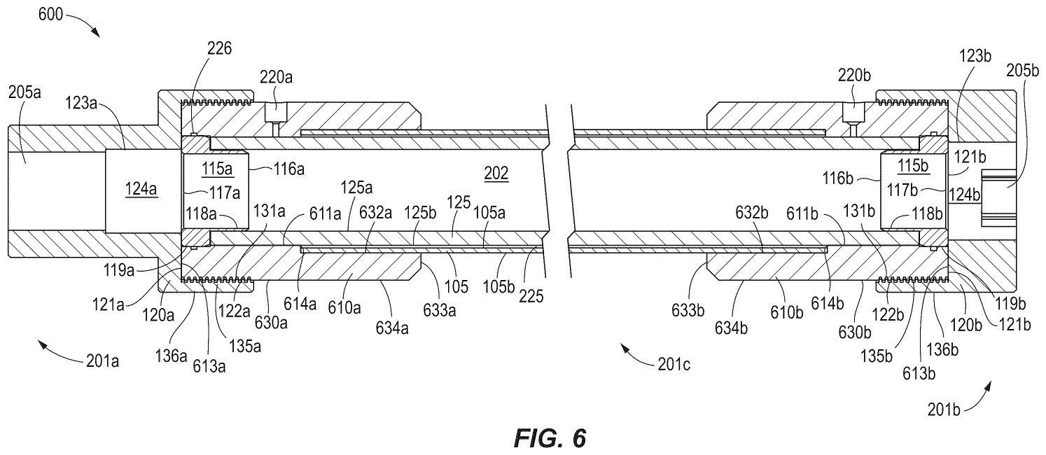

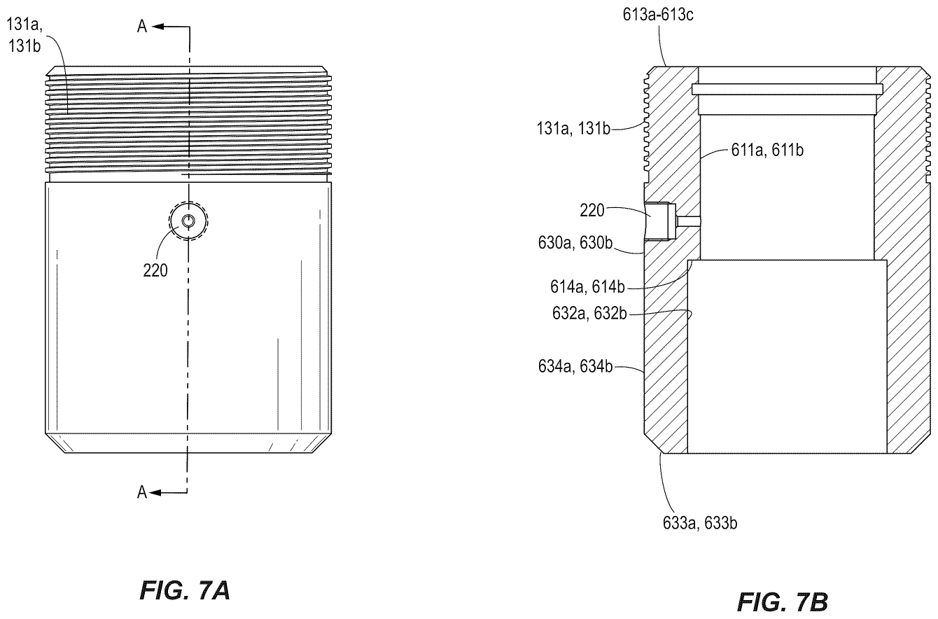

FIG. 6 is a cross-sectional view of an example core holder 600 according to at least one embodiment of the present disclosure. FIGS. 7A and 7B show example end pieces 610a, 610b (collectively, end pieces 610) for use with core holder 600. The end pieces 610 may be made of, or formed from, aluminum, nickel, an aluminum alloy, a nickel alloy (for example, Hastelloy), stainless steel, or combinations thereof. The end pieces 610 may be anodized. For example, the end piece may be made of, or formed of, aluminum, and anodized prior to being adhered to core tube 105. The core tube 105 is adhered to the two end pieces 610 using an adhesive. Using aluminum allows an anodizing process that increases the surface roughness of the metal surface and provides a more stable anodized film, thereby making adherence between the end pieces and the core tube more reliable.

As shown in FIGS. 6, 7A, and 7B, the shape of the end pieces 610 and the manner in which it is combined with the core tube 105 are modified. In FIG. 2A, the core tube 105 is adhered to the second surface 112 of the end piece 110, and the end piece 110 is shaped accordingly. Also in core holder 200 of FIG. 2A, portions of end pieces 610 are positioned between the core tube 105 and the internal sleeve 125. In the design of core holder 600 shown in FIG. 6, the core tube 105 is in contact with and adhered to an inner surface (seventh surface 632) of the end piece 610.

Each of the end pieces 610 includes: a first surface 611a, 611b (collectively, first surface 611); a second surface 630a, 630b (collectively, second surface 630) opposite the first surface 611; a third surface 613a, 613b (collectively, third surface 613); a fourth surface 614a, 614b (collectively, fourth surface 614) opposite the third surface 613; a fifth surface 634a, 634b (collectively, fifth surface 634) opposite the first surface 611; a sixth surface 633a, 633b (collectively, sixth surface 633) opposite the third surface 613; a seventh surface 632a, 632b (collectively, seventh surface 632) opposite the fifth surface 634; and threads 131a, 131b (collectively, threads 131) defining a portion of the second surface 630. The first surface 611 defines a first inner diameter of the end piece 610 and the seventh surface 632 defines a second inner diameter of the end piece 610. The second surface 630, the fifth surface 634, and threads 131 defines an outer diameter of the end piece 610. The sixth surface 633 and the fourth surface 614 are separated by the seventh surface 632.

Confining fluid ports 220 are in fluid communication with a confining fluid chamber 225. The confining fluid chamber 225 is positioned between the core tube 105 and the internal sleeve 125. More specifically, the confining fluid chamber 225 is defined by the first surface 105a (an inner diameter) of the core tube 105, the second surface 125b (outer diameter) of the internal sleeve 125, and the fourth surfaces 614a, 614b of the first and second end pieces 610a, 610b, respectively. O-ring 226 may be used to prevent confining fluid from escaping the confining fluid chamber 225. As described herein, the confining fluid chamber 225 is adapted to accommodate a confining fluid (such as mineral oil) to apply confining pressure to the internal sleeve 125. During use, confining fluid is transmitted to the confining fluid chamber 225 through the confining fluid ports 220. The internal sleeve 125 is, for example, adapted to contact a core sample in response to a confining pressure applied to the internal sleeve 125 in the confining fluid chamber 225.

The seventh surface 632 of each end piece 610 is coupled to (or adhered to or bonded to) the second surface 105b (an outer diameter) of the core tube 105 by an adhesive. The adhesive is a structural adhesive. The adhesive may be any suitable resin such as an epoxy resin. Suitable epoxy resins include Hysol epoxy resin. A suitable Hysol epoxy resin includes Henkel Loctite Hysol EA 9394 C-2 Aero Epoxy commercially available from Krayden.

The seventh surface 632 of each end piece 610 may have a roughened or textured surface. The roughened/texture surface may increase the coupling (or adhering or bonding) strength between the second surface 632 of each end piece 610 and the second surface 105b of the core tube 105.

The fourth surface 614 traps an end of the core tube 105. The fourth surface 119 (second outer diameter) of the end cone 115 is coupled to the first surface 611 (inner diameter) of the end piece 610. The first surface 121 of the end cap 120 traps the end piece 610 and the end cone 115 upon securing the end cap 120 to the end piece 610. Upon securing, the first surface 121 of the end cap 120 and the third surface 613 of the end piece 610 are adjacent. The first surface 611 of end piece 610 contacts the second surface 125b (outer diameter) of the internal sleeve 125.

FIGS. 7A and 7B show different views of a non-limiting example of the end piece 610 for a macro-scale core holder design. Specifically, FIG. 7A shows a side view of the end piece 610, and FIG. 7B shows a cross-sectional view, taken along segment A-A, of the example end piece shown in FIG. 7A. The end piece 610 may include interior grooves (not shown) similar to interior grooves 140 illustrated with end piece 110 in FIG. 3A. An o-ring may be positioned in the grooves to seal a confining fluid. The o-ring may be made of any suitable material such as a fluoroelastomer described herein. As illustrated in FIGS. 7A and 7B, the end piece 610 includes a confining fluid port 220. Confining fluid may travel through the confining fluid port 220 to the confining fluid chamber 225.

Example core holders described herein may be manufactured in a machine shop. Example core holders of the present disclosure, as example apparatus, are useful for performing core-flood tests. During use, a core sample is placed in the internal sleeve of an example core holder, for example, core holder 200 or core holder 600. In some implementations, an example core-flooding apparatus may include the example core holder 600 and an X-ray computed tomography (CT) scanner system coupled (for example, optically) to the example core holder 600. In some implementations, an example core-flooding apparatus may include the example core holder 200 and an X-ray computed tomography (CT) scanner system coupled (for example, optically) to the example core holder 200.

The core-flooding apparatus may be adapted to perform a core-flood test. The X-ray CT scanner system may include an X-ray CT scanner for scanning tomography and recording X-ray CT images/scans and a computer system for post-processing of the X-ray CT images. Example post-processing may include, but is not limited to, measuring and analyzing porosity, quantifying fluid saturations, monitoring front movements in the core, calculating recovery factors, or other types of analyses for evaluating effectiveness of hydrocarbon recovery techniques. The X-ray CT scanner system may be used to monitor imbibition or saturation of a core sample. The X-ray CT scanner is a non-destructive tool that is utilized to measure various properties of the core sample and occupancies of fluids in the porous media during core-flood testing.

In use, an example core holder described herein may be assembled by the following non-limiting procedure. The core tube 105 is adhered to two end pieces 110 using an adhesive. The internal sleeve 125 is positioned inside the end pieces 110. End cones 115 are installed into the ends of internal sleeve 125. An o-ring may be positioned on the outside diameter (the fourth surface 119) of the end cones and in an interior groove 140 of the end piece 110. The end caps 120 are screwed onto the respective end pieces 110 via the threads 122 of the end caps 120 and threads 131 of the end pieces 110 and then tightened using suitable equipment. A core sample is positioned inside the internal sleeve 125. The first nozzle 205a is installed in one end cap 120a and a second nozzle 205b is installed in the other end cap 120b.

The example core holder is positioned vertically and mineral oil may be loaded into the confining fluid chamber 225 via the confining fluid ports 220. The mineral oil applies surrounding stress (confining stress) to the core sample. During testing, fluids (for example, a hydrocarbon liquid (for example, crude petroleum), an aqueous liquid (for example, brine), a gas (for example, CO₂ gas, N₂ gas, methane gas), or combinations thereof) may be injected through the first nozzle 205a and into the interior volume 202 where it enters the core sample. Such fluids may be collected from the core sample via a second nozzle 205b. During testing, the core sample may be imaged using an X-ray CT scanner system.

Embodiments of the present disclosure also relate to performing core-flood testing using an example core holder (for example, core holder 200 or core holder 600) and/or a core-flooding apparatus. As described above, the example core-flooding apparatus includes or is otherwise coupled to an X-ray CT scanner system. A first set of CT images of the core sample may be collected prior to injecting fluids into the core sample. A core-flood test may then be performed on the core sample located inside the interior volume 202 of the core holder. A second set of CT images of the core sample may then be collected during or after the core-flood test.

The core-flood test may include a saturation test. To saturate the core sample, a confining pressure may be applied to the internal sleeve 125 by injecting a confining fluid (for example, mineral oil) into the confining fluid chamber via the confining fluid ports 220. Confining the core ensures that the injected fluids (such as aqueous fluids) are imbibed into the core sample. Performing the core-flood test may include injecting an aqueous fluid (for example, water, brine, etc.), with or without a chemical additive (for example, surfactant, polymer, etc.), into the core sample while the confining pressure is applied to the core sample; injecting a hydrocarbon (for example, crude oil and/or other hydrocarbon fluid) into the core sample while the confining pressure is applied to the core sample; injecting gas (for example, nitrogen, CO₂, CH₄, H₂, etc.) into the core sample while the confining pressure is applied to the core sample; or combinations thereof. This core-flood test may include collecting CT images during the saturation test. For example, the CT images may be collected during the aqueous fluid saturation phase, the hydrocarbon saturation phase, or both phases. If desired, a gas such as CO₂ may be injected into the core sample before the aqueous fluid is injected.

The core-flood test may include an imbibition test. Performing the core-flood test may include (a) injecting a hydrocarbon (for example, crude oil and/or other hydrocarbon fluid) into the core sample; (b) injecting an aqueous fluid (water, brine, etc.), with or without chemical additives (for example, surfactant, polymer, etc.), into the core sample; (c) injecting a gas (for example, nitrogen, CO₂, CH₄, H₂, etc.) into the core sample; or (d) combinations thereof. The injection of the aqueous fluid into the core sample of operation (b) simulates a water flood, while the injection of the gas into the core sample of operation (c) simulates a gas flood. The water flood and the gas flood may include injection of different or additional injection fluids. This core-flood test may include collecting CT images during the imbibition test. For example, the CT images during the fluid injection of operation (a), the water flood of operation (b), the gas flood of operation (c), and or combinations thereof may be collected and analyzed to determine fluid saturation.

Overall, the CT images collected during performance of methods described herein provide a core sample saturation history during the core-flood testing. The effectiveness of oil recovery techniques (for example, effectiveness of the surfactant flood) may be determined based on the series of CT images.

### EXAMPLES

An example core holder was designed to work in harsh conditions that mimic or simulate actual conditions. For example, the example core holder may withstand a temperature of about 250° F. (120° C.), a working pressure of about 10,000 psi, and with a safety factor of about 1.5. In addition, the core holder having the core sample therein may be scanned by an X-ray computed tomography scanner during high-temperature, high-pressure core-flooding experiments. Overall, example core holders described herein enable, for example, improved accuracy in characterizing three-dimensional fluid occupancies and calculating in-situ fluid saturation based on computed tomography numbers during X-ray scanned core-flooding tests.

### Example Core Holder

An example core holder was designed to accommodate a ˜1.5-inch diameter cylindrical-shaped core sample with a length of up to about 11 inches. This may maximize the pore volume of the core sample, and increase the reliability of the generated results during core-flooding tests.

The core tube was made of carbon fiber to minimize X-ray attenuation. Dimensions of the core tube included: an inner diameter of about 3 inches, a thickness of about 0.170 inches, and a length of about 20 inches.

The example core holder further included two ends. Each of the two ends included an end cap and an end piece. The end cap and end piece for each of the ends were threadedly connected to one another to lock the end cap to the end piece. End caps and end pieces were made of Hastelloy TMC-276 and aluminum, respectively. The aluminum end pieces were anodized.

On each end of the core tube, about 4.5 inches of the core tube was adhered to the two end pieces using a resin such as Henkel Loctite Hysol EA 9394 C-2 Aero Epoxy. Therefore, the length of the core sample to be installed in the core holder was about 11 inches in order to avoid the impacts of the metal end pieces on the X-ray imaging quality of the core sample.

An AFLAS fluoroelastomer internal sleeve was positioned inside the core tube. The internal sleeve holds the ˜1.5-inch diameter core sample. The AFLAS fluoroelastomer material minimizes gas (CO₂ and/or hydrocarbon) diffusion between the porous media of the core sample and a confining fluid chamber during core-flooding tests. The dimensions of the internal sleeve included: an inner diameter of about 1.62 inches, a thickness of about 0.23 inches, and a length of about 24 inches.

Both ends of the AFLAS internal sleeve are installed into end cones. End cones were made of Hastelloy TMC-276. The nozzles are installed into the end caps.

Mineral oil was used as a confining fluid. Mineral oil was injected into a confining fluid chamber via confining fluid ports. Fluids (for example, hydrocarbon liquids, aqueous fluids, and/or gases) were injected into the interior volume of the core holder via the nozzle.

### EMBODIMENTS LISTING

The present disclosure provides, among others, the following embodiments, each of which may be considered as optionally including any alternate embodiments:

Clause A1. A high-pressure, high-temperature core holder adapted to be coupled to an X-ray computed tomography scanner, comprising:
a core tube defining an outside diameter of a core holder, the core tube formed of an X-ray transparent material;
an internal sleeve in the core tube, the internal sleeve formed of a flexible material comprising a fluoroelastomer, the internal sleeve comprising:
   an inner diameter defining an interior volume of the core holder and adapted to accommodate a core sample; and
   an outer diameter; and
a first end piece and a second end piece opposite the first end piece, each of the first end piece and the second end piece:
   adhered to an outer diameter of the core tube with a structural adhesive; and
   adjacent to a confining fluid chamber.

Clause A2. The core holder of Clause A1, wherein the core holder is adapted to withstand, and operate under, an overburden pressure that is from about 1,000 psi to about 10,000 psi (from about 6.9 MPa to about 69 MPa), a core pressure that is from about 200 psi to about 8,000 psi (from about 1.4 MPa to about 55 MPa), and a temperature that is from about 104° F. to about 250° F. (from about 40° C. to about 120° C.).

Clause A3. The core holder of any one of Clauses A1-A2, further comprising:
a first end cone and a second end cone opposite the first end cone, wherein:
   the first end cone and the second end cone are coupled to the inner diameter of the internal sleeve and adapted to seal the interior volume of the core holder;
   the first end cone is coupled to an inner diameter of the first end piece; and
   the second end cone is coupled to an inner diameter of the second end piece.

Clause A4. The core holder of any one of Clauses A1-A3, further comprising:
a first end cap and a second end cap opposite the first end cap, wherein:
   the first end cap is threadedly coupled to an outer diameter of the first end piece; and
   the second end cap is threadedly coupled to an outer diameter of the second end piece.

Clause A5. The core holder of any one of Clauses A1-A4, wherein:
the core holder further comprises a confining fluid port adapted to receive a confining fluid; and
the confining fluid chamber is in fluid communication with the confining fluid port, the confining fluid chamber adapted to receive the confining fluid, the confining fluid chamber defined by:
   the core tube;
   the first and second end pieces; and
   the internal sleeve.

Clause A6. The core holder of Clause A5, wherein: the internal sleeve is adapted to contact the core sample in response to a confining pressure applied to the internal sleeve in the confining fluid chamber.

Clause A7. The core holder of any one of Clauses A1-A6, further comprising:
a first nozzle comprising a first plurality of ports in fluid communication with the interior volume of the core holder; and
a second nozzle opposite the first nozzle, the second nozzle comprising a second plurality of ports, the second plurality of ports in fluid communication with the interior volume of the core holder.

Clause A8. The core holder of Clause A7, wherein the first plurality of ports are operable to inject fluid into the interior volume of the core holder and to the core sample.

Clause A9. The core holder of any one of Clauses A7-A8, wherein the second plurality of ports are operable to collect fluid exiting the core sample.

Clause A10. The core holder of any one of Clauses A1-A9, wherein the X-ray transparent material comprises carbon fiber.

Clause A11. The core holder of any one of Clauses A1-A10, wherein the fluoroelastomer comprises a copolymer comprising tetrafluoroethylene.

Clause A12. The core holder of any one of Clauses A1-A11, wherein the fluoroelastomer comprises a copolymer comprising tetrafluoroethylene and propylene.

Clause A13. The core holder of any one of Clauses A1-A12, wherein the core sample comprises a porous geomaterial, such as carbonate, sandstone, shale, or combinations thereof.

Clause B1. A core-flooding apparatus adapted to perform a core-flood test, comprising: the core holder of any one of Clauses A1-A13, the core holder adapted to be coupled to an X-ray computed tomography scanner system to monitor imbibition or saturation of a core sample comprising a geomaterial.

Clause C1. A process, comprising:
performing a core-flood test on a core sample disposed inside the core holder of any one of Clauses A1-A13 or the core-flooding apparatus of Clause B1, the core sample comprising porous media;
collecting X-ray computed tomography images of the core sample while performing the core-flood test; and
determining characteristics of the core sample and a fluid in the porous media of the core sample based on the X-ray computed tomography images, the characteristics of the core sample and the fluid in the porous media comprising: a porosity, a permeability, relative permeability, a fluid saturation, saturation change, damage caused by a fluid injection, interaction between the fluid injected and the core sample, or combinations thereof.

Clause C2. The process of Clause C1, wherein the core-flood test comprises an imbibition test.

Clause C3. The process of any one of Clauses C1-C2, wherein the core-flood test comprises a saturation test.

Clause C4. The process of any one of Clauses C1-C3, further comprising, collecting an X-ray computed tomography image prior to performing the core-flood test.

Clause C5. The process of any one of Clauses C1-C4, wherein the performing the core-flood test on the core sample comprises:
injecting an aqueous fluid into the core sample when a confining pressure is applied to the core sample;
injecting a hydrocarbon into the core sample when a confining pressure is applied to the core sample; or
combinations thereof.

Clause C6. The process of Clause C5, further comprising injecting a gas into the core sample before, during, or after the injecting the aqueous fluid, the hydrocarbon, or combinations thereof.

Clause D1. A high-pressure, high-temperature core holder adapted to be coupled to an X-ray computed tomography scanner, comprising:
a core tube defining an outside diameter of a core holder, the core tube formed of an X-ray transparent material;
an internal sleeve in the core tube, the internal sleeve formed of a flexible material comprising a fluoroelastomer, the internal sleeve comprising:
   an inner diameter defining an interior volume of the core holder and adapted to accommodate a core sample; and
   an outer diameter; and
a first end piece and a second end piece opposite the first end piece, each of the first end piece and the second end piece:
   adhered to an inner diameter of the core tube with a structural adhesive; and
   adjacent to a confining fluid chamber.

Clause D2. The core holder of Clause D1, wherein the core holder is adapted to withstand, and operate under, an overburden pressure that is from about 1,000 psi to about 10,000 psi (from about 6.9 MPa to about 69 MPa), a core pressure that is from about 200 psi to about 8,000 psi (from about 1.4 MPa to about 55 MPa), and a temperature that is from about 104° F. to about 250° F. (from about 40° C. to about 120° C.).

Clause D3. The core holder of any one of Clause D1 or Clause D2, further comprising:
a first end cone and a second end cone opposite the first end cone, wherein:
the first end cone and the second end cone are coupled to the inner diameter of the internal sleeve and adapted to seal the interior volume of the core holder.
the first end cone is coupled to an inner diameter of the first end piece; and
the second end cone is coupled to an inner diameter of the second end piece.

Clause D4. The core holder of any one of Clauses D1-D3, further comprising:
a first end cap and a second end cap opposite the first end cap, wherein:
the first end cap is threadedly coupled to an outer diameter of the first end piece; and
the second end cap is threadedly coupled to an outer diameter of the second end piece.

Clause D5. The core holder of any one of Clauses D1-D4, wherein:
the core holder further comprises a confining fluid port adapted to receive a confining fluid; and
the confining fluid chamber is in fluid communication with the confining fluid port, the confining fluid chamber adapted to receive the confining fluid, the confining fluid chamber defined by:
   the core tube;
   the first and second end pieces; and
   the internal sleeve.

Clause D6. The core holder of Clause D5, wherein:
the internal sleeve is adapted to contact the core sample in response to a confining pressure applied to the internal sleeve in the confining fluid chamber.

Clause D7. The core holder of any one of Clauses D1-D6, further comprising:
a first nozzle comprising a first plurality of ports in fluid communication with the interior volume of the core holder; and
a second nozzle opposite the first nozzle, the second nozzle comprising a second plurality of ports, the second plurality of ports in fluid communication with the interior volume of the core holder.

Clause D8. The core holder of Clause D7, wherein the first plurality of ports are operable to inject fluid (for example, oil, natural gas, brine, CO₂, CH₄, N₂, H₂, or combinations thereof) into the interior volume of the core holder and to the core sample.

Clause D9. The core holder of any one of Clause D7 or Clause D8, wherein the second plurality of ports are operable to collect fluid (for example, oil, natural gas, brine, CO₂, CH₄, N₂, H₂, or combinations thereof) exiting the core sample.

Clause D10. The core holder of any one of Clauses D1-D9, wherein the X-ray transparent material comprises carbon fiber.

Clause D11. The core holder of any one of Clauses D1-D10, wherein the fluoroelastomer comprises a copolymer comprising tetrafluoroethylene.

Clause D12. The core holder of any one of Clauses D1-D11, wherein the fluoroelastomer comprises a copolymer comprising tetrafluoroethylene and propylene.

Clause D13. The core holder of any one of Clauses D1-D12, wherein the core sample comprises a porous geomaterial, such as carbonate, sandstone, shale, or combinations thereof.

Clause E1. A core-flooding apparatus adapted to perform a core-flood test, comprising:
the core holder of any one of Clauses D1-D13, the core holder adapted to be coupled to an X-ray computed tomography scanner system to monitor imbibition or saturation of a core sample comprising a geomaterial.

Clause E1. A process, comprising:
performing a core-flood test on a core sample disposed inside the core holder of any one of Clauses D1-D13 or the core-flooding apparatus of Clause E1, the core sample comprising porous media;
collecting X-ray computed tomography images of the core sample while performing the core-flood test; and
determining characteristics of the core sample and a fluid in the porous media of the core sample based on the X-ray computed tomography images, the characteristics of the core sample and the fluid in the porous media comprising: a porosity, a permeability, relative permeability, a fluid saturation, saturation change, damage caused by a fluid injection, interaction between the fluid injected and the core sample, or combinations thereof.

Clause E2. The process of Clause E1, wherein the core-flood test comprises an imbibition test.

Clause E3. The process of any one of Clause E1 or Clause E2, wherein the core-flood test comprises a saturation test.

Clause E4. The process of any one of Clauses E1-E3, further comprising, collecting an X-ray computed tomography image prior to performing the core-flood test.

Clause E5. The process of any one of Clauses E1-E4, wherein the performing the core-flood test on the core sample comprises:
injecting an aqueous fluid into the core sample when a confining pressure is applied to the core sample;
injecting a hydrocarbon into the core sample when a confining pressure is applied to the core sample; or
combinations thereof.

Clause E6. The process of Clause E4, further comprising injecting a gas into the core sample before, during, or after the injecting the aqueous fluid, the hydrocarbon, or combinations thereof.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, embodiments comprising “a fluid” include embodiments comprising one, two, or more fluids, unless specified to the contrary or the context clearly indicates only one fluid is included.

While the foregoing is directed to embodiments of the present disclosure, other and further aspects of the disclosure may be devised without departing from the basic scope thereof, and the scope thereof is determined by the claims that follow.

What is claimed is:

1. A high-pressure, high-temperature core holder adapted to be coupled to an X-ray computed tomography scanner, the comprising:
a core tube defining an outside diameter of a core holder, the core tube formed of an X-ray transparent material;
an internal sleeve in the core tube, the internal sleeve formed of a flexible material comprising a fluoroelastomer, the internal sleeve comprising:
an inner diameter defining an interior volume of the core holder and adapted to accommodate a core sample; and
an outer diameter; and
a first end piece and a second end piece opposite the first end piece, each of the first end piece and the second end piece:
adhered to an outer diameter of the core tube with a structural adhesive; and
adjacent to a confining fluid chamber.

2. The core holder of claim 1, wherein the core holder is adapted to withstand, and operate under, an overburden pressure that is from about 1,000 psi to about 10,000 psi, a core pressure that is from about 200 psi to about 8,000 psi, and a temperature that is from about 104° F. to about 250° F.

3. The core holder of claim 1, further comprising:
a first end cone and a second end cone opposite the first end cone, wherein:
the first end cone and the second end cone are coupled to the inner diameter of the internal sleeve and adapted to seal the interior volume of the core holder;
the first end cone is coupled to an inner diameter of the first end piece; and
the second end cone is coupled to an inner diameter of the second end piece.

4. The core holder of claim 1, further comprising:
a first end cap and a second end cap opposite the first end cap, wherein:
the first end cap is threadedly coupled to an outer diameter of the first end piece; and
the second end cap is threadedly coupled to an outer diameter of the second end piece.

5. The core holder of claim 1, wherein:
the core holder further comprises a confining fluid port adapted to receive a confining fluid; and
the confining fluid chamber is in fluid communication with the confining fluid port, the confining fluid chamber adapted to receive the confining fluid, the confining fluid chamber defined by:
the core tube;
the first and second end pieces; and
the internal sleeve.

6. The core holder of claim 5, wherein:
the internal sleeve is adapted to contact the core sample in response to a confining pressure applied to the internal sleeve in the confining fluid chamber.

7. The core holder of claim 1, further comprising:
a first nozzle comprising a first plurality of ports in fluid communication with the interior volume of the core holder; and
a second nozzle opposite the first nozzle, the second nozzle comprising a second plurality of ports, the second plurality of ports in fluid communication with the interior volume of the core holder.

8. The core holder of claim 7, wherein the first plurality of ports are operable to inject fluid into the interior volume of the core holder and to the core sample.

9. The core holder of claim 7, wherein the second plurality of ports are operable to collect fluid exiting the core sample.

10. The core holder of claim 1, wherein the X-ray transparent material comprises carbon fiber.

11. The core holder of claim 1, wherein the fluoroelastomer comprises a copolymer comprising tetrafluoroethylene.

12. The core holder of claim 1, wherein the fluoroelastomer comprises a copolymer comprising tetrafluoroethylene and propylene.

13. The core holder of claim 1, wherein the core sample comprises a porous geomaterial.

14. A core-flooding apparatus adapted to perform a core-flood test, comprising:
an X-ray computed tomography scanner system; and
a high-pressure, high-temperature core holder coupled to the X-ray computed tomography scanner system, the core holder comprising:
a core tube defining an outside diameter of a core holder, the core tube formed of an X-ray transparent material;
an internal sleeve in the core tube, the internal sleeve formed of a flexible material comprising a fluoroelastomer, the internal sleeve comprising:
an inner diameter defining an interior volume of the core holder and adapted to accommodate a core sample; and
an outer diameter; and
a first end piece and a second end piece opposite the first end piece, each of the first end piece and the second end piece:
adhered to an outer diameter of the core tube with a structural adhesive; and
adjacent to a confining fluid chamber.

15. A process, comprising:
performing a core-flood test on a core sample disposed inside a high-pressure, high-temperature core holder, the core sample comprising porous media, the core holder comprising:
a core tube defining an outside diameter of a core holder, the core tube formed of an X-ray transparent material;
an internal sleeve in the core tube, the internal sleeve formed of a flexible material comprising a fluoroelastomer, the internal sleeve comprising:
an inner diameter defining an interior volume of the core holder and adapted to accommodate a core sample; and
an outer diameter; and
a first end piece and a second end piece opposite the first end piece, each of the first end piece and the second end piece:
adhered to an outer diameter of the core tube with a structural adhesive; and
adjacent to a confining fluid chamber;
collecting X-ray computed tomography images of the core sample while performing the core-flood test; and
determining characteristics of the core sample and a fluid in the porous media of the core sample based on the X-ray computed tomography images, the characteristics of the core sample and the fluid in the porous media comprising: a porosity, a permeability, relative permeability, a fluid saturation, saturation change, damage caused by a fluid injection, interaction between the fluid injected and the core sample, or combinations thereof.

16. The process of claim 15, wherein the core-flood test comprises an imbibition test.

17. The process of claim 15, wherein the core-flood test comprises a saturation test.

18. The process of claim 15, further comprising, collecting an X-ray computed tomography image prior to performing the core-flood test.

19. The process of claim 15, wherein the performing the core-flood test on the core sample comprises:
injecting an aqueous fluid into the core sample when a confining pressure is applied to the core sample;
injecting a hydrocarbon into the core sample when a confining pressure is applied to the core sample; or
combinations thereof.

20. The process of claim 19, further comprising injecting a gas into the core sample before, during, or after the injecting the aqueous fluid, the hydrocarbon, or combinations thereof.
